(19) United States
(12) Patent Application Publication
(10) Pub. No.: US 2004/0040127 A1
(43) Pub. Date: Mar. 4, 2004

(54) Get -a-Grip handheld clamp extension arms

(76) Inventor: Martin Edward Hellkamp, Roanoke, VA (US)

Correspondence Address: Martin Edward Hellkamp, 5336 Huntridge Rd., Roanoke, VA, 24012, US

(21) Appl. No.: 10/648,082

(22) Filed: Aug. 26, 2003

Related U.S. Application Data
(60) Provisional application No. 60/406,060, filed on Aug. 27, 2002.

(51) Int. Cl. B42F 1/00

(52) U.S. Cl. 24/460

(57) ABSTRACT

Existing hand held Quick-Grip® bar clamps that are sold on the market have a limitation in the distance away from the clamp bar that two objects can be clamped. This limitation is the distance that the Quick-Grip® bar clamp heads are located from the front of the clamp bar. This invention is designed to slide over the heads of these existing clamps and extend the distance that two objects can be clamped together away from the Quick-Grip® clamp bar. This is new in that the original function of the Quick-Grip® bar clamp remains the same with the extension arms in place or with the extension arms removed. These extension arms are easily installed by hand and removed by hand. The clamp extension arms can be used in a reverse position to be used when the Quick-Grip® bar clamp is in the spreader position.

### CROSS—REFERENCE TO RELATED APPLICATIONS

This patent application references and incorporates prior provisional application No. 60/406,060, filing date Aug. 27, 2002. The relationship of the applications is that this utility patent application is being filed by the same applicant that filed for the above referenced provisional patent, and with some modifications contained in this application, the two applications, this one and the prior provisional application are for the same invention.

### STATEMENT REGARDING FEDERALLY SPONSORED RESEARCH OF DEVELOPMENT

This section is not applicable for this application.

### REFERENCE TO SEQUENCE LISTING, A TABLE, OR A COMPUTER PROGRAM LISTING COMPACT DISK APPENDIX

This section is not applicable for this application.

### BACKGROUND OF THE INVENTION

The field of endeavor to which this invention pertains is the field of mechanics and hand held tools. More specifically, this invention is directly related to and used with already existing Quick-Grip® hand held and/or hand operated bar clamps. Although the idea of this invention has expanded applications to other market available clamps, this invention is designed specifically for use with the hand held Quick-Grip® bar clamp. The illustrations and drawings contained in this application show that the invention is used as an add on extension arm for these Quick-Grip® bar clamps. Refer to FIG. 1.

As referenced above in the non-provisional application in paragraph 001, this invention addresses the specific problem of the limited clamp reach that exists with Quick-Grip® bar clamps that are already available to the consumer. The “clamp reach” is defined as the distance that a clamp allows the user to effectively clamp an object or objects away from the back bar (leading edge) of the clamp. FIG. 2 shows an existing Quick-Grip® bar clamp and identifies the clamp reach for this specific clamp as 2.25 inches. The “clamp reach” by definition is measured from the leading edge of the clamp bar to the leading edge of the clamp head as shown in FIG. 2.

### BRIEF SUMMARY OF THE INVENTION

The idea and purpose of this invention is to increase the limited “clamp reach” problem addressed in paragraph 006 above. The advantage of this invention is that a pair of these clamp extension arms can be added to any QuickGrip® bar clamp head by sliding the extension arm over the existing clamp head, (refer back to FIG. 1), resulting in an increase in the usable clamp reach without altering, interfering or hindering the Quick-Grip® bar clamp that the extension arms are used on.. When not in use, the extension arms are easily removed, and the original clamp remains usable and in tact. The advantages to this invention are that: a) it preserves the use and design of any Quick-Grip® bar clamp it is used on, b) it increases the limited effective clamp reach that existing QuickGrip® bar clamps have. FIG. 2 shows the clamp reach of an existing clamp as 2.25 inches, with the addition of the clamp extension arms, the clamp reach is increased to 8.00 inches as seen in FIG. 1. The increase of the clamp reach to 8.00 inches is related to the length of the clamp extension arm used, which is related to the manufactured length of the extension arm (5.75 inches in this illustration) but not related to the design of the extension arm. These extension arms can be manufactured to fit different size Quick-Grip® bar clamp heads and made with different lengths to achieve longer and shorter clamp reaches.

### BRIEF DESCRIPTION OF THE SEVERAL VIEWS OF THE DRAWING

FIG. 1: Drawing showing invention in use as an add-on extension arm to the hand held Quick-Grip® bar clamp.

FIG. 2: Drawing defining “clamp reach” of existing Quick-Grip® bar clamps.

FIG. 3: Drawing showing top view of invention.

FIG. 4: Drawing showing front view of invention.

FIG. 5: Drawing showing cut view of end of invention that slides over existing Quick-Grip® bar clamp heads.

FIG. 6: Drawing showing side view of Existing Quick-Grip® bar clamp head prior to sliding on to extension arm. Arrows show direction of slide.

### DETAILED DESCRIPTION OF THE INVENTION

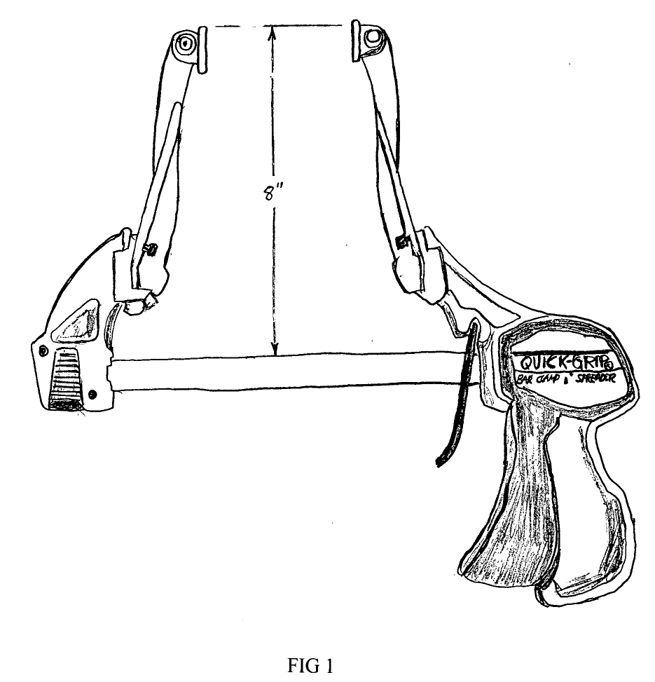

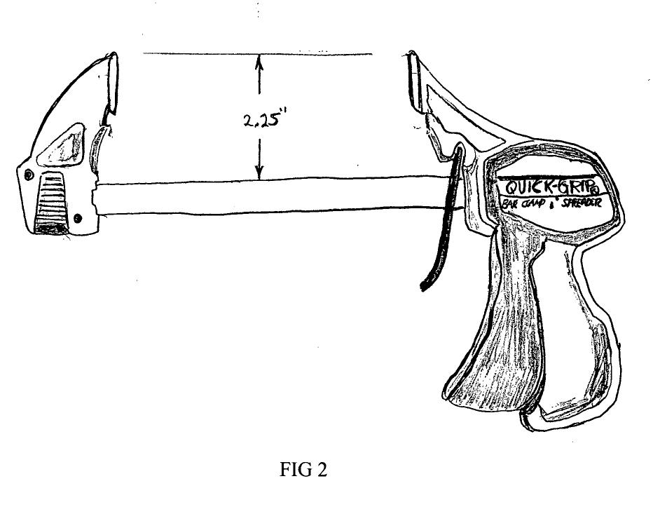

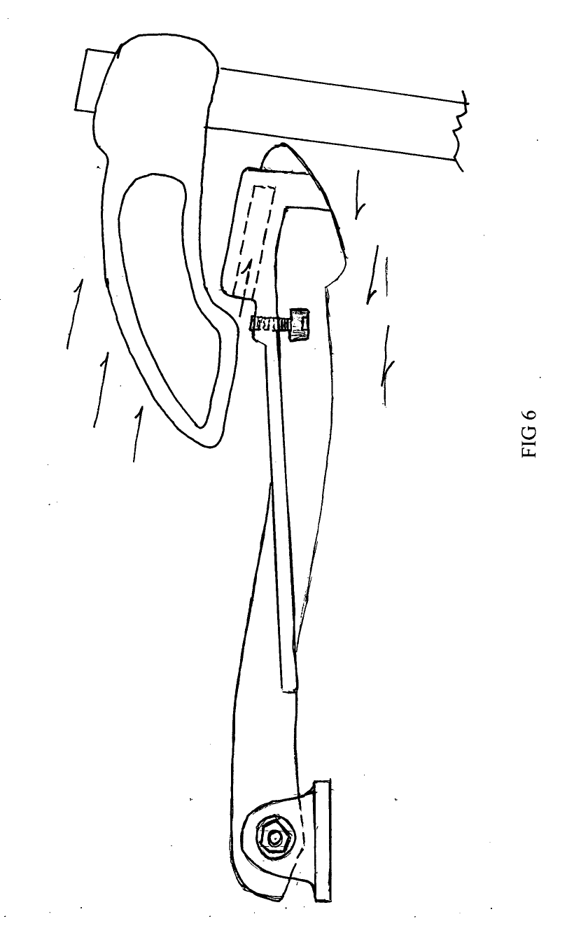

The invention is an extension arm used in conjunction with existing hand held Quick-Grip® bar clamps. These clamps, that are readily available on the market, have a limited reach distance that two objects can be clamped together. (Clamp reach distance is defined in paragraph 005) This invention extends this reach distance and is used with these existing hand held Quick-Grip® bar clamps. The extension arm is designed so that the mounting slot of the extension arm shown in Reference 2 of FIG. 4 slides over the rectangular clamp head of these Quick-Grip® bar clamps, see FIG. 6. The extension arms slide onto the existing clamp heads from the back side of the existing clamp heads. The extension arm can be secured in place on the Quick-Grip® bar clamp head after sliding it into place with two set screws as referenced in FIG. 5, Reference 4. These set screws are not essential to the operation or design of the invention and can be considered optional in the manufacturing of the invention. Without the set screws the extension arms will still operate. Once in place on an existing Quick-Grip® bar clamp as shown in FIG. 1, objects being clamped together can now be clamped further away from the leading edge of the original clamp bar. The length of the extension arm is a function of manufacturing. This size of the slide mounting slot of this invention can vary in manufacturing to fit the different sizes of Quick-Grip® bar clamp heads that are already on the market.

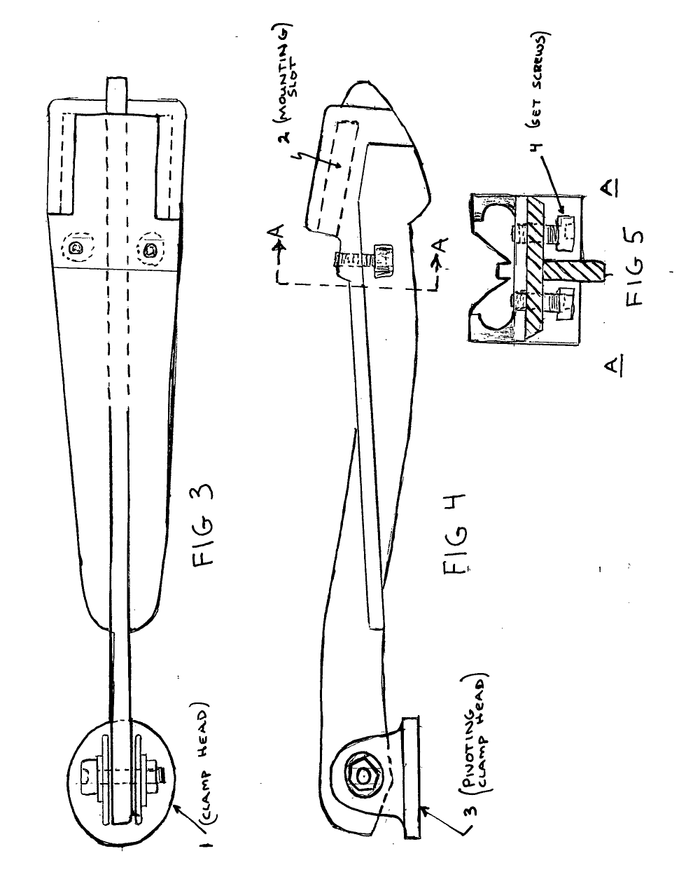

The clamp head of the extension arm is designed to swivel as shown in FIG. 4, Reference 3. This design gives the maximum clamp strength when using the clamp extension arms. Although maximizing the clamp strength is important, this pivoting clamp head design feature is an optional feature of the clamp extension arms. In the manufacturing of the clamp extension arms it may prove more cost effective to make the heads of the clamp extension arms fixed and one piece. The shape of the heads of the clamp extension as seen in FIG. 3, Reference 1 are shown as oval. This shape is also a variable of manufacturing; the extension arms will still function if the shape of the extension arm clamp head is rectangular, similar to the shapes of the clamp heads on the existing Quick-Grip® bar clamps that the extension arms are used in conjunction with.

The extension arms can be manufactured out of a variety of light weight metals through the casting type of molding. They may also be manufactured out of a strong polymer plastic through the injection molding process. The arms can be manufactured in either process as a one piece design by eliminating the optional set screws as discussed above and eliminating the pivoting clamp head as also discussed above. In the event that the pivoting clamp head and the set screws are maintained in manufacturing, assembly of the clamp extension arms would be necessary prior to distribution. The difference in manufacturing for the pivoting clamp head would require the pivot hole to be molded into both the clamp head and the clamp arm as shown in FIG. 3 and FIG. 4. The manufacturing addition of the set screws in the mounting slide portion of the clamp extension arm would require threading two holes into the clamp extension arms and adding the two set screws through the threaded holes. In any of the manufacturing processes discussed above, the function of the clamp extension arms remains the same.

This invention is different in that it is an add-on device to existing QuickGrip® bar clamps that are already on the market. It does not alter the existing clamp in any way, and once removed, the existing clamp is back to its original state. This invention is added to the existing Quick-Grip® bar clamps by first removing any padding that is on the heads of the Quick-Grip® bar clamp. This padding slides off. Once the padding is removed, the clamp extension arms slide on to the existing bar clamp head. (FIG. 6 and FIG. 1) The extension arms slide from the leading edge of the bar of the Quick-Grip® bar clamp forward toward tip of the clamp head. The extension arms slide until the back stop of the extension arm is reached. Once in place, the Quick-Grip® bar clamp can now be used normally. To remove the extension arms the above process is reversed. With this invention in place, the existing Quick-Grip® bar clamps can now grip objects at a farther distance away from the bar of the clamp without loosing clamping ability.

1. I claim my invention to be clamp extension arms that increase the clamp reach of existing Quick-Grip® bar clamps by sliding these extension arms over the existing clamp heads of the Quick-Grip® bar clamps.

2. I claim that the shape of the portion of this invention that slides over the existing Quick-Grips® bar clamp head and the way it is positioned and fits on the existing clamp head after sliding it into place are unique to this invention.

3. I claim that the pivoting clamp head of the invention gives the maximum clamping strength for the extension arms but is not required for the clamp extension arms to function properly and could be manufactured as a solid piece, head and arm fixed with respect to each other, as well as have different shapes, i.e. oval, rectangular, round etc.

4. I claim that the set screws diagramed and discussed for mounting these clamp extension arms onto the existing Quick-Grip® bar clamp heads are optional and that the design of this invention allows the extension arms to slide into place, fitting securely and functioning without the set screws.

5. I claim that the invention can be manufactured through a variety of processes and using a variety of materials and that
the invention's shape can be altered and extension arm length changed without changing the invention's intended operation.

6. I claim that when the invention is removed from the original Quick-Grip® bar clamp that it was used on, the original clamp is unaltered and will function as it was originally designed.

7. I claim that the invention slides onto the Quick-Grip® bar clamp heads simply by removing any clamp head padding and sliding the extension arms into place by hand.

8. I claim that the invention can be used on the Quick-Grip® bar clamp when using the bar clamp as a spreader by reversing the side that the extension arm head faces.
